(19) United States
(12) Patent Application Publication
(10) Pub. No.: US 2016/0240033 A1
(43) Pub. Date: Aug. 18, 2016

(54) Tilt Hopper

(71) Applicant: Automated Merchandising Systems, Inc., Kearneysville, WV (US)

(72) Inventors: Kenneth B. Tenney, Winchester, VA (US); David Mark Campbell, Winchester, VA (US); Michael Vincent Smith, Kearneysville, WV (US); Daniel W. Ahl, SR., Martinsburg, WV (US)

(73) Assignee: AUTOMATED MERCHANDISING SYSTEMS, INC., Kearneysville, WV (US)

(21) Appl. No.: 14/624,253

(22) Filed: Feb. 17, 2015

(51) Int. Cl. G07F 11/60

(52) U.S. Cl. CPC G07F 11/60

(57) ABSTRACT

A product retrieval mechanism for vending machines that permits collection of varying size products at a first level yet presents such products for collection at a raised height to make retrieval more convenient. The retrieval mechanism utilizes a movable floor within the hopper that movable between a lowered position and a higher position for presenting the product at a higher retrieval point relative to the floor upon opening of the hopper.

### COPYRIGHT NOTICE

A portion of the disclosure of this patent document contains material that is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### FIELD OF THE DISCLOSURE

This disclosure relates to vending machines and more specifically to a product retrieval system that receives a dispensed product at one level and presents that product at a different and higher level for collection.

### INTRODUCTION

### Glossary: As Used Throughout this Document

The term “hopper” and the phrase “tilt hopper” shall mean a form of retrieval bin characterized by having a bottom or floor that is movable between lowered and raised positions, for example one lowered position that will assist in the initial receipt of any sized product that is dispensed from a product tray or other product retaining mechanism there above in a vending machine into the retrieval bin or hopper and onto an actual floor within the hopper or bin structure, yet when the retrieval door is opened the floor will have been moved to its raised position to thereby present such a dispensed item for collection by a purchaser at a higher point and thereby be in compliance with and will meet the latest Americans with Disability Act requirements.

The term “retrieval mechanism” refers to a system used in a vending machine that receives dispensed product at a first lower level and when accessed by the consumer, presents that dispensed product at a second higher level for collection by that customer.

The term “actual floor” or “actual bottom” means the lowered, true floor within the hopper of the retrieval mechanism when the retrieval door is closed and the security shield is open, with the depth of the actual floor being defined by the vertical dimension at the center of the interior of the hopper.

### DESCRIPTION OF PRESENTLY PREFERRED EXAMPLES OF THE INVENTION

### Brief Description of Figures

The invention is better understood by reading the following detailed description with reference to the accompanying drawings in which:

FIG. 1 is a front elevational view of the vending machine;

FIG. 2 is a cross-sectional view taken along line 2-2 in FIG. 1;

FIG. 3 is an perspective view of the hopper from the front side;

FIG. 4 is a perspective view of the hopper from the rear thereof;

FIG. 5 is a perspective view of the bottom of the hopper;

FIG. 6 is a front elevational view of the side of the hopper showing the floor in a lowered condition, with parts having been omit for clarity;

FIG. 7 is a cross sectional view taken along line 7-7 in FIG. 6;

FIG. 8 is a front elevational view of the side of the hopper showing the floor in a raised condition, with parts having been omit for clarity;

FIG. 9 is a cross sectional view taken along line 9-9 in FIG. 8;

FIG. 10A is a cross sectional view taken along line 10-10 in FIG. 6;

FIG. 10B shows an enlarged elevational drawing of the door stop cam;

FIG. 11 shows an end view of an open retrieval bin mechanism with the security shield in a fully open, non-shielding position;

FIG. 12 shows an end view of the hopper with the security shield in a partially closed position;

FIG. 13 shows a retrieval bin mechanism in which the security shield in its closed, shielding position;

FIG. 14 shows a front elevational view of the hopper delivery door with parts having been deleted for clarity;

FIG. 15 shows a side view of the delivery door taken along line 14-14 in FIG. 13; and

FIG. 16 shows a control circuit for the present invention.

### DETAILED DESCRIPTION

### A. Overview

To gain a better understanding of the invention, a preferred embodiment will now be described in detail. Frequent reference will be made to the drawings, and reference numerals or letters will be used throughout to indicate certain parts or locations in the drawings. The same reference numerals or letters will be used to indicate the same parts and locations throughout the drawings, unless otherwise indicated.

### B. Environment

The preferred embodiment now described will be with respect to a glass front vending machine. The scale of the embodiment, therefore, is to be understood with respect to this type of device or equipment. However, the present retrieval system could work for other vending machines, for example closed front vending equipment, so long as the path of travel of a vended product was directed into the hopper opening when the retrieval door is in its closed position. It is to be understood as well, however, that the invention is applicable to other articles and its scale can vary accordingly.

It can be pointed out as well that the hopper or hopper assembly disclosed and discussed herein can be smaller and more compact and positioned at a lower level in the vending machine thereby permitting a larger product holding section as the bottom thereof can extend downwardly an additional distance lower that would otherwise be the case with a higher and less compact hopper or retrieval assemblies. Consequently, vend capacity and shelf height can be maximized.

### C. Structure

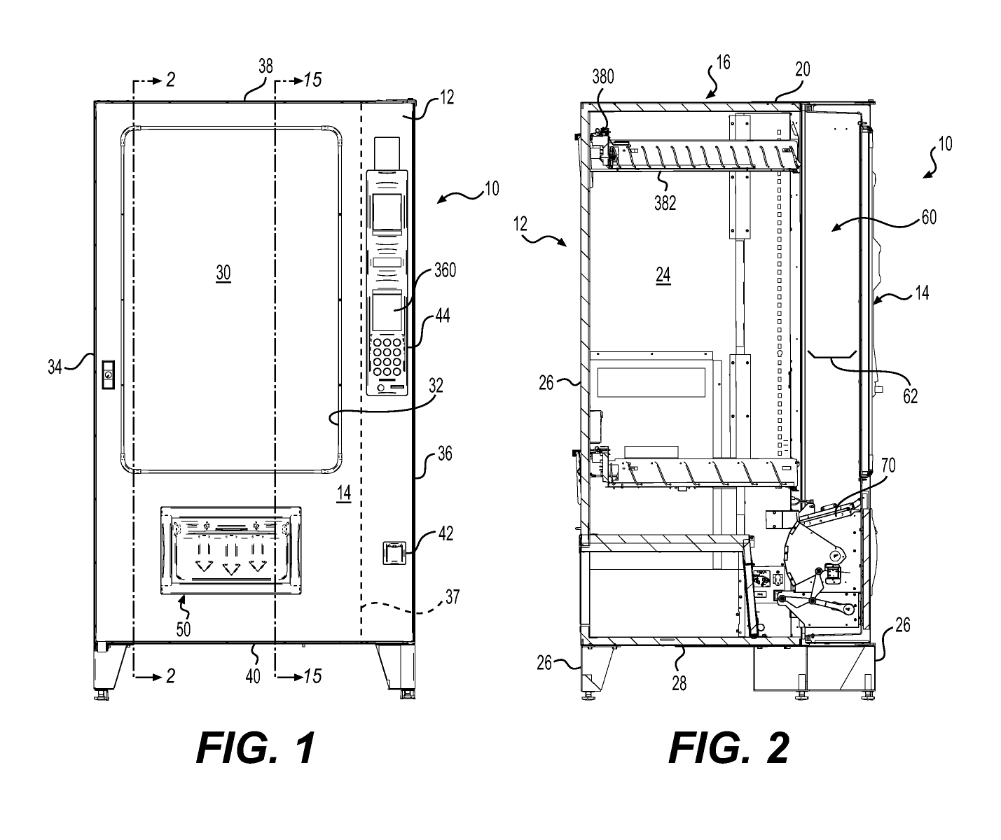

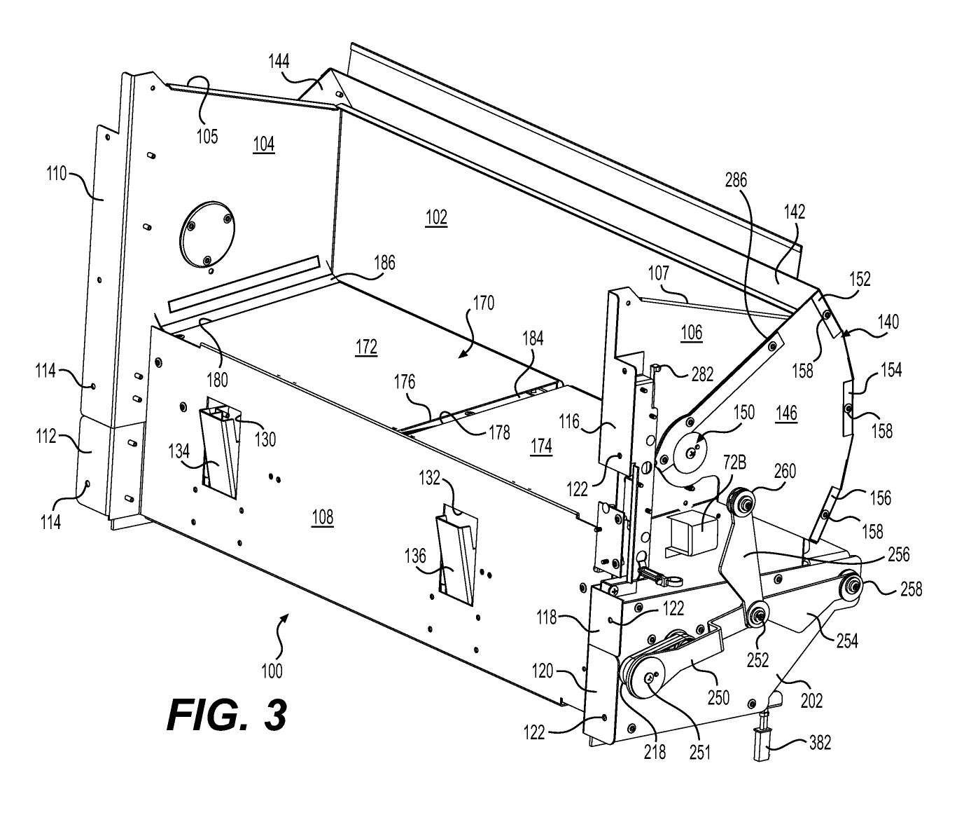

FIGS. 1 and 2 show such a glass front vending machine 10 as being comprised of an outer casing 12 comprised of a front door 14 that is hinged or otherwise attached to a rear portion 16 comprised, for example, with a top wall 20, opposing side walls 22 and 24, and rear and bottom walls, 26 and 28, respectively, as well as a plurality of height adjustable feet 26. The front door 14 and the rear portion 16 collectively define the outer casing structure 12 for the vending machine 10.

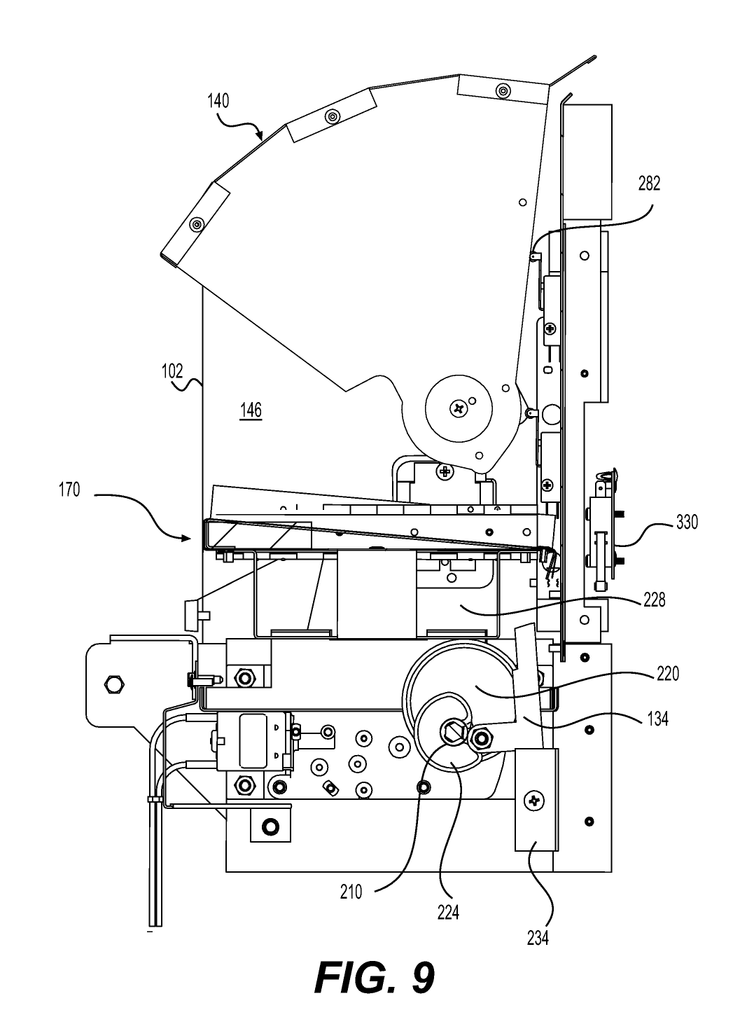

The front door 14 includes a glass front 30 that is retained in a front panel 32, as well as opposite sides 34 and 36, a top 38 and a bottom 40. Door 14 also includes a change return 42, a suitable keypad control panel 44, a display 360 and a retrieval mechanism 50. As shown in FIG. 8, an additional vertical interior wall 37 can be provided at a point spaced inwardly from side wall 36 with the space between walls 36 and 37 providing room to mount other parts of the vending machine such as, for example, electronics, a coin changer assembly, a bill validator or other devices as may be desired on vending equipment. The amount of spacing between walls 36 and 37 varies with the size and capacity of the vending machine 10 and therefore also affects the relative size of retrieval mechanism 50.

Inside the vending machine 10 is a product holding section 60, as shown in FIG. 2, that can include any form or grouping of known product dispensing assemblies, product holding and dispensing trays, or other product holding and dispensing devices as one might envision for such a vending machine 10. The precise content, size, structure and configuration of the product holding section 60 can include or encompass a wide variety thereof limited only by the particular products one might choose to vend from each tray or device within the vending machine as a whole. Suitable vend motors 380 can be used as needed on each dispensing tray 382 or product dispensing arrangement however designed to dispense product therefrom. Also included inside the vending machine is a vend space 62 that exists both vertically and horizontally, with the horizontal width being defined by and between the interior portions of the vertically extending side walls 34 and 37, and with a front-to-back depth defined between the front of the product holding section 60 and the inside of glass 30. A dispensed product will fall through this vend space 62 and into the retrieval mechanism 50.

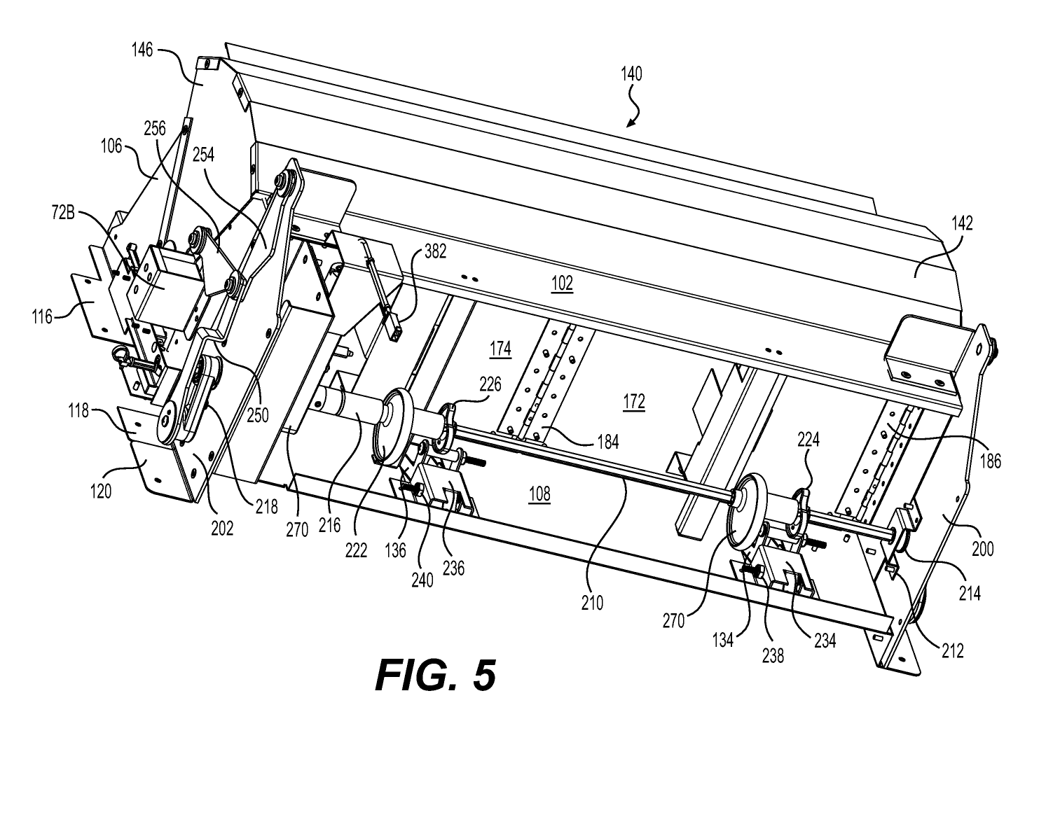

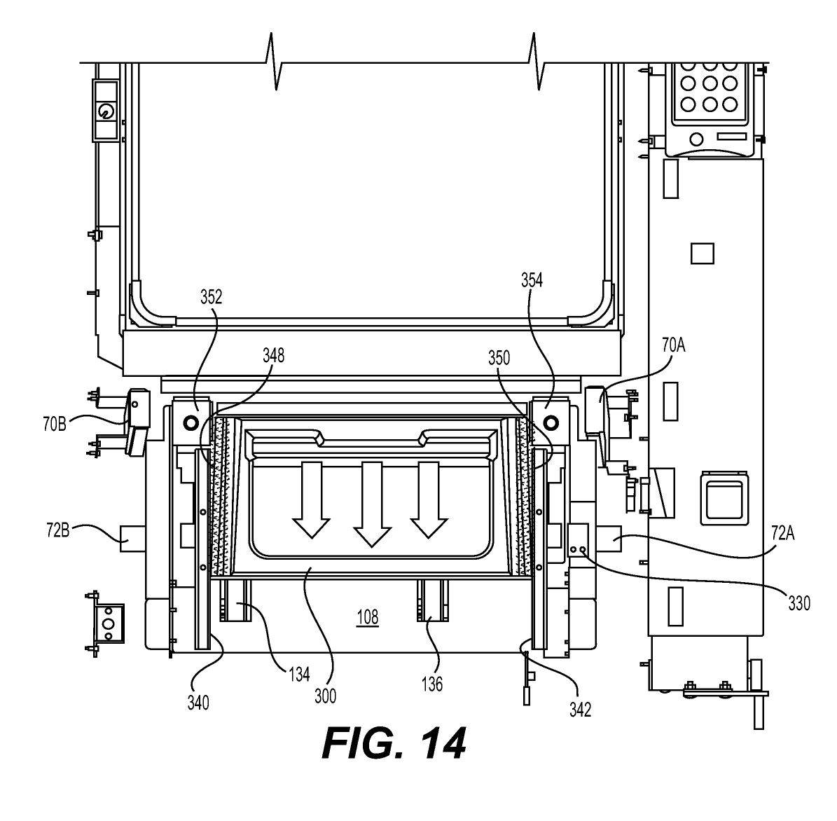

The vending machine 10 can also include a vend sensing system, for example a Sensit® system which can be better understood by reference to U.S. Pat. No. 6,384,402, incorporated herein by reference thereto. This vend sensing system is shown generally at 70 in FIG. 4 and includes an emitter/detector unit 70A on one side of the vend space 62 and a second emitter/detector 70B unit on the opposite side, along with suitable control equipment, and comprises a product vend detection system for the vending equipment. This sensing system can, for example, be positioned as shown in FIGS. 4 and 14 adjacent the bottom of the vend space 62 but just above the hopper mechanism 100 and for example, can be directed above and across the depth or the front to back dimension of the top edges 105 and 107 of walls 104 and 106, respectively. A sensing plane of radiation will be generated to extend and operate across the depth and width of the vend space 62 to sense the vending of a product as it falls through the Sensit® radiation plane into the retrieval mechanism.

When glass bottles or fragile products are being vended it may be desirable to also provide an additional product sensor 72 with, for example an emitter or emitter/detector combination 72A on one side of the hopper space and a detector or emitter/detector combination 72B on an opposite side of the hopper, to detect that a product is actually located within the hopper itself to prevent another product from being vended on top of such a glass or fragile product already within the hopper.

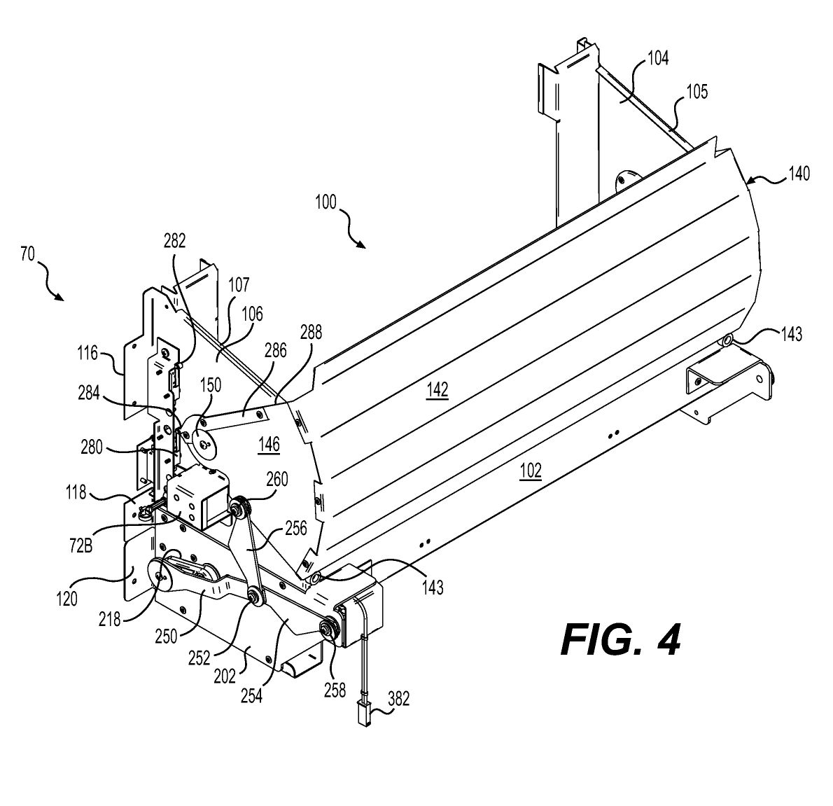

Turning to FIGS. 3 and 4 the retrieval mechanism 50 can include a hopper assembly, shown generally at 100, that can include an inner hopper structure comprised of a rear or back wall 102, side walls 104 and 106, and a front wall or panel 108. Side wall 104 includes a front portion comprised an upper tab or flange 110 and a lower tab or flange 112 bent at about a 90° angle to side wall 104, with each having a plurality of mounting holes 114 provided therein thereby permitting the hopper assembly 100, for example, to be mounted to door 14. Side wall 106 also includes a series of tabs or flanges 116, 118 and 120, also bent at about 90° to side wall 106, which have mounting holes 122 provided therein.

Front panel 108 includes two spaced apart openings 130 and 132 thus providing an opening through which pivotally mounted doorstops 134 and 136 can operate, respectively, as will be discussed further below.

The hopper assembly 100 also includes a pivotally mounted security shield 140 having a curved main section 142 that is curved, with a front edge 141, a rear edge 145, and end panels 144 and 146 each of which is respectively pivotally mounted to side walls 104/106 by pivot assemblies 148 and 150, respectively. The curved main section 142, for example if formed from stamped sheet metal, can be provided with tabs or flanges as are shown at 152, 154 and 156 that are secured to the end walls, for example as is shown in FIG. 3 for end wall 146, by rivets 158. The curved main section 142 can be connected to end wall 144 in a similar manner. Alternatively, the curved main section 142 might be formed with end walls 144 and 146 as a one piece molded structure from a moldable material, for example a plastic, thermoplastic or a polycarbonate type of material, in which case the connecting flanges and rivets would not be needed. As shown in FIG. 4 the shield 140 is in its open position and its rear edge 145 will rest on spaced apart stops or bumpers 143.

The hopper assembly can be made from sheet metal, for example, and the gauge thereof can vary from 12 to 22. Alternatively, the hopper assembly could be molded form a plastic or reinforced plastic, as well as a polycarbonate, or other similar man made types of materials.

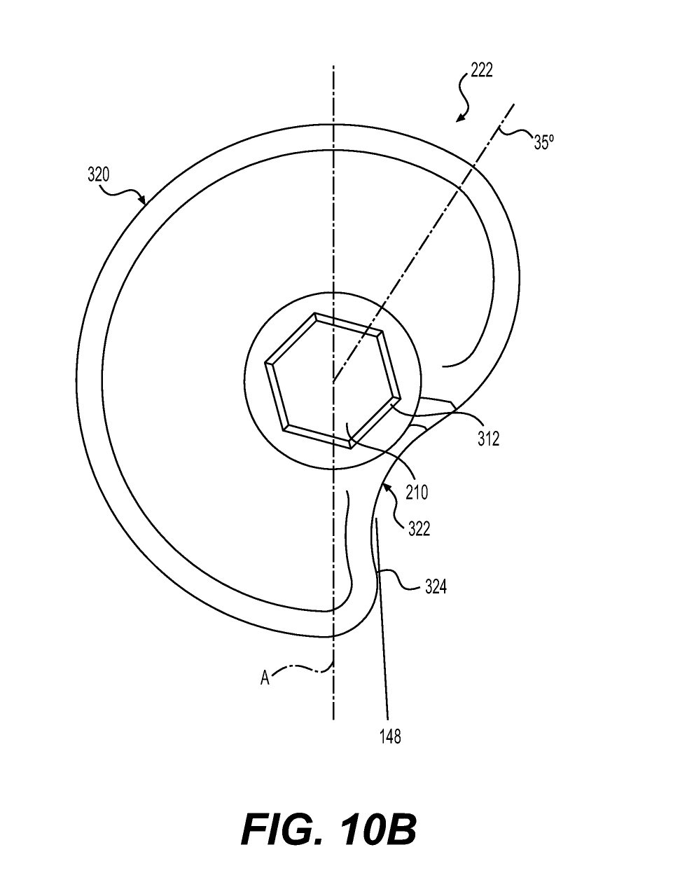

The hopper assembly 100 also includes a bottom interior wall, generally shown at 170, which can be comprised of substantially flat first and second floor sections, 172 and 174 respectively. Each of the floor sections 172/174 have an inner edge 176 and 178, and outer edges 180 and 182. The two inner edges 176/178 are movably connected to one another, for example by being pivotally connected through a central hinge 184, while outer edge 180 of section 172 is movably connected to side wall 104, for example, by a hinge 186. The other outer edge 182 is also movably connected to side wall 106, again for example by a hinge 188. A pair of stops 190 and 192 are provided on a back surface of rear wall 102 and are located near a bottom edge to provide a positive stop for an fully opened position for security shield 140 as is shown in FIG. 10.

What is important is that floor sections 172/174 are moved relative to each other, and relative to hopper side walls 104/106. One example, as noted, is to use hinges to permit pivotal motion. However, other forms of hinge devices or structures could also be employed, for example, use of man-made materials such as polycarbonate, polyethylene, plastics, or other such materials a hinges or floor section connectors that would permit floor sections 172/174 to be moved between their lowered and raised positions.

On each side of the hopper assembly 100 is a pivot link mounting bracket 200 and 202 that can be riveted or otherwise secured to a lower portion of side walls 104/106. As an alternative, tabs or flanges 110 and 120 could also be formed as a part of that bracket 200/202, as opposed to the side walls 104/106, and are still bent at a ninety degree angle.

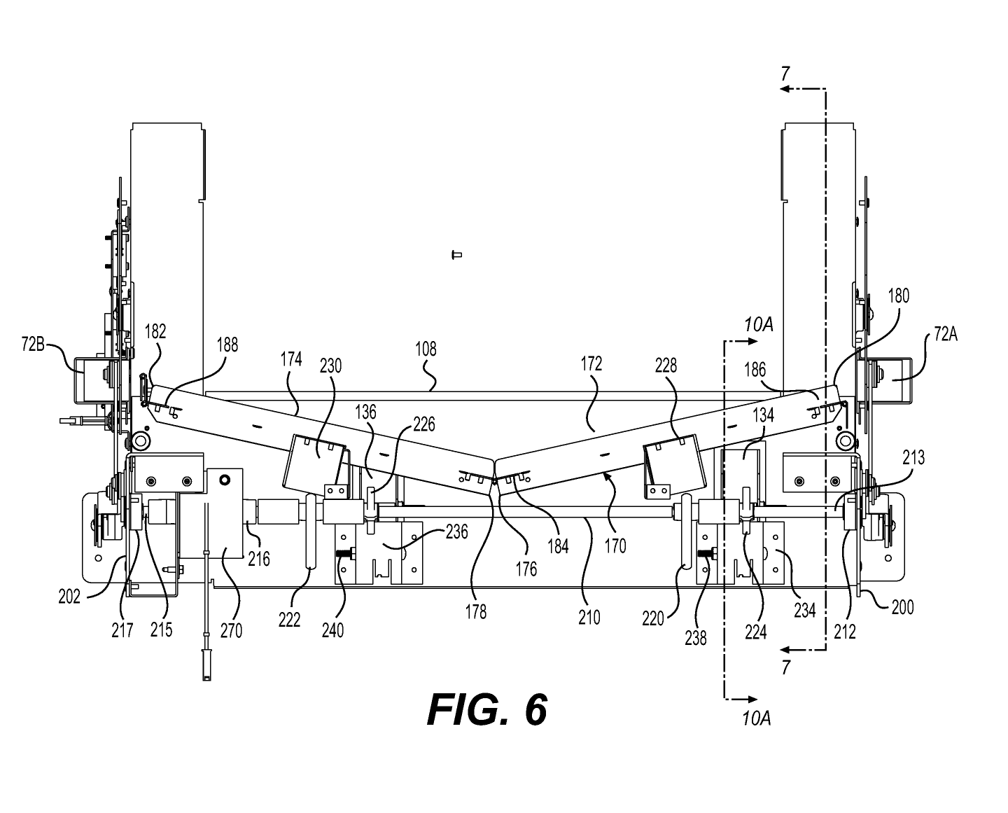

With reference to FIGS. 5, 6 and 8, the bottom area of the hopper assembly 100 can be seen and shows a first and long horizontally extending drive shaft 210, having for example a hexagonal cross sectional shape, that is mounted at one end 213 to an inside surface of bracket 200 by a retaining bracket 212, that can be riveted to bracket 200, with the end of shaft 210 itself being supported therein by a snap in NYLINER® bearing 214. The opposite end 215 of drive shaft 210 extends into a motor 270, to which it is drivingly connected. A second short drive shaft 216 has one end that is also operatively connected to motor 270 and a second end that is rotationally supported by a bearing 217 in bracket 202 and is operatively connected and fixed to one end of a drive link 218.

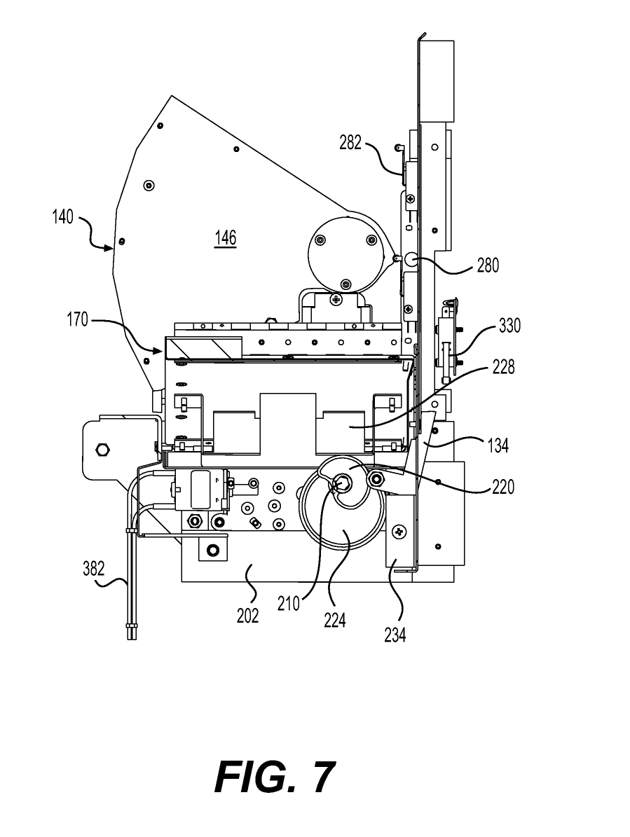

Drive shaft 210 supports a pair of large cam discs, 220 and 222, and a pair of smaller cam discs 224 and 226. The large cam discs 220 and 222 work with cam followers 228 and 230 that are attached to the bottom of floor sections 172 and 174, respectively. As FIG. 6 shows, when cam discs 220 and 222 are rotated to a first position by motor 270, the floor sections 172/174 will be in a lowered condition. When cam discs 220/222 have been rotated 180 degrees, as in FIG. 8 from the previous position of FIG. 6, cam discs 220/222 will have moved followers 228/230 upwardly thereby moving floor sections 172/174 to a fully raised condition making the floor flat and having raised any selected and vended product resting on floor 170. To meet ADA requirements the floor 170 will preferably move about 2.25 inches from its lowest point, shown in FIG. 6, to its highest point, shown in FIG. 8. A wider range for this floor movement would be possible to fit other vending machine mechanisms or vended product sizes.

Shaft 210 also drives smaller cam discs 224 and 226 that will move against door stops 134 and 136, respectively. Those door stops 134/136 are pivotally supported in brackets 234 and 236 by pins or bolts 238 and 240.

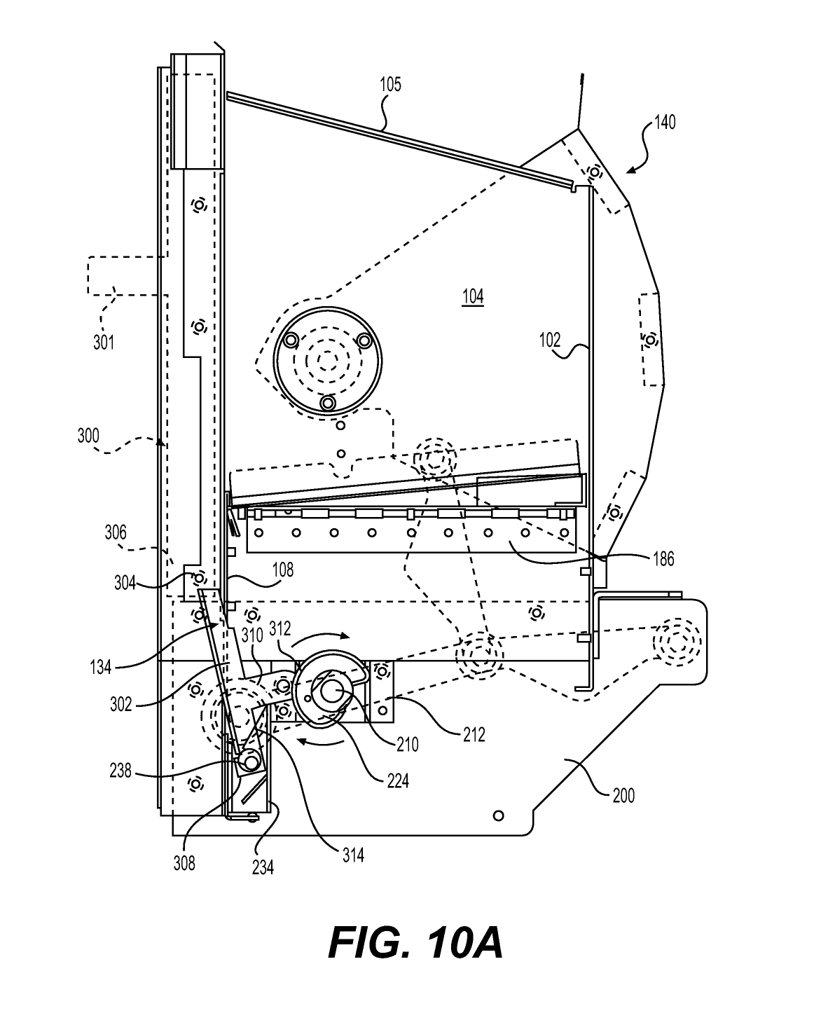

The larger cam discs 220 and 222 have an outer diameter of 2.33 inches and the center of the drive shaft 210 is 0.56 inches from the short side and 1.77 inches from the ling side. The smaller cam discs 224 and 226 have a specially designed shape, as shown in FIG. 9 and in greater detail in FIG. 10, with an overall outer diameter of about 1.5 inches, and with the center of drive shaft 210 being about 0.312 inches from the short side and about 0.750 inches from the longer side. Both sets of cams can be formed, for example, from a Lexan® 923a polycarbonate material or a like material.

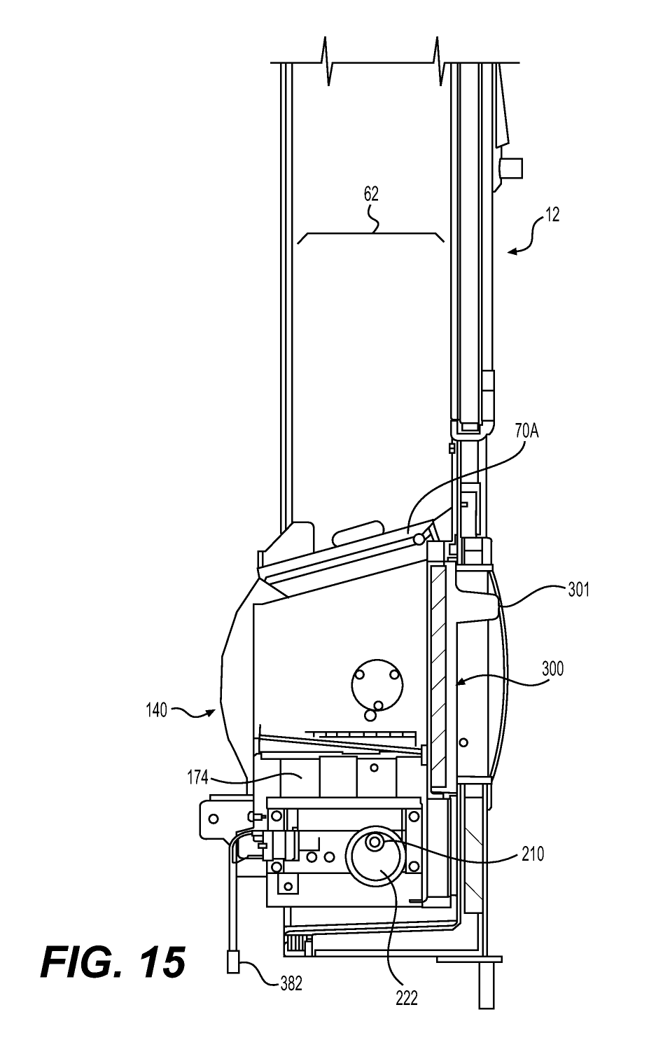

FIGS. 1, 9, 10A, 14 and 15 show the retrieving door 300 that can move between a down or open position and in a up or closed position. In FIG. 10A, stop 134 is shown as having a “T” shape with a long portion 302 with a top end 304 that will engage the bottom 306 of door 300, a bottom end 308 that is pivotally connected by a pin 238 to a bracket 234 that is secured to front wall 108 as shown in FIGS. 5, 6 and 10, and a short arm 310 having an outer end 312. Each stop 134/236 is mounted to be biased inwardly by a spring 314. Cams 224/226 as shown in FIG. 10B will be rotated clockwise by the drive shaft 210. In order to again place stops 134/136 back in their out or locking position, drive shaft 215 will once again be rotated and surface 324 will eventually be brought into contact with the contact end 312 of the short arm 310 and continued rotation will thereby push stop 134/136 outwardly against the force of spring 314 toward their outward or door stopping, locked positions.

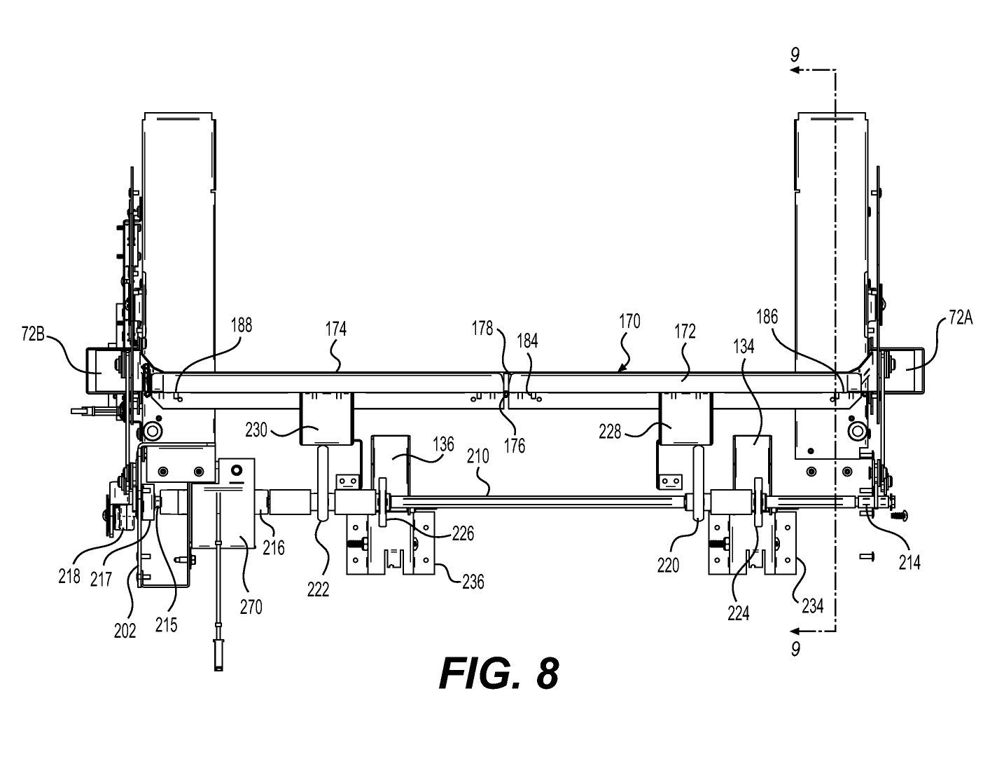

The position of door 300 will be monitored by a switch 330, shown in FIGS. 7, 9, 14 and 16, that will be actuated by door 300 when moved into its closed or up position. When switch 330 is actuated or closed drive shaft 210 can rotate cams 222/224 to push stops 134/136 into their stop position as just described.

Door 300 will slide within rails 340 and 342 and each side 344 and 346 will be attached to a spring 348 and 350 that will be pulled from a reel mounted within an enclosure 352 and 354 located adjacent the upper corners of door 300. As door 300 is moved downwardly into its open condition springs 348/350 will be pulled from enclosures 352/354 and will be biased to help move door 300 upwards into its closed condition.

Cams 224/226 have a defined outer shape, as shown in FIG. 10B, comprising a major portion of the outer periphery or circumference, as indicated at 320, and a shallowed profile 322. If a vertical axis “A” is drawn on the cam 224 in FIG. 10B, the major circumferential portion 320 extends, for example, from about 35° counter clockwise to about 180°, with the shallowed portion beginning at about the same 35° point but extending clockwise to about the same 180° point. The entire outer periphery will come into contact with end 312 of the top members 134/136 and depending upon the rotation of shaft 210 the stops 134/136 will be held in an projected or locked condition for holding door 300 and preventing door 300 from being opened, as shown in FIG. 10A, or in a biased inward condition as shown in FIG. 9. While end 312 is in contact with the major portion 320 the stop 134/136 remains closed, but as end begins to be contacted by the shallow side adjacent the 35° point the stop 134/136 will begin its movement out of contact with stops 134/136 and the top end 304 will move inwardly and out of contact with the bottom 306 of door 300. As drive shaft 210 moves to raise floor 170 and to present a dispensed product for collection and the door 300 will then be unlocked and openable by moving handle 301 down.

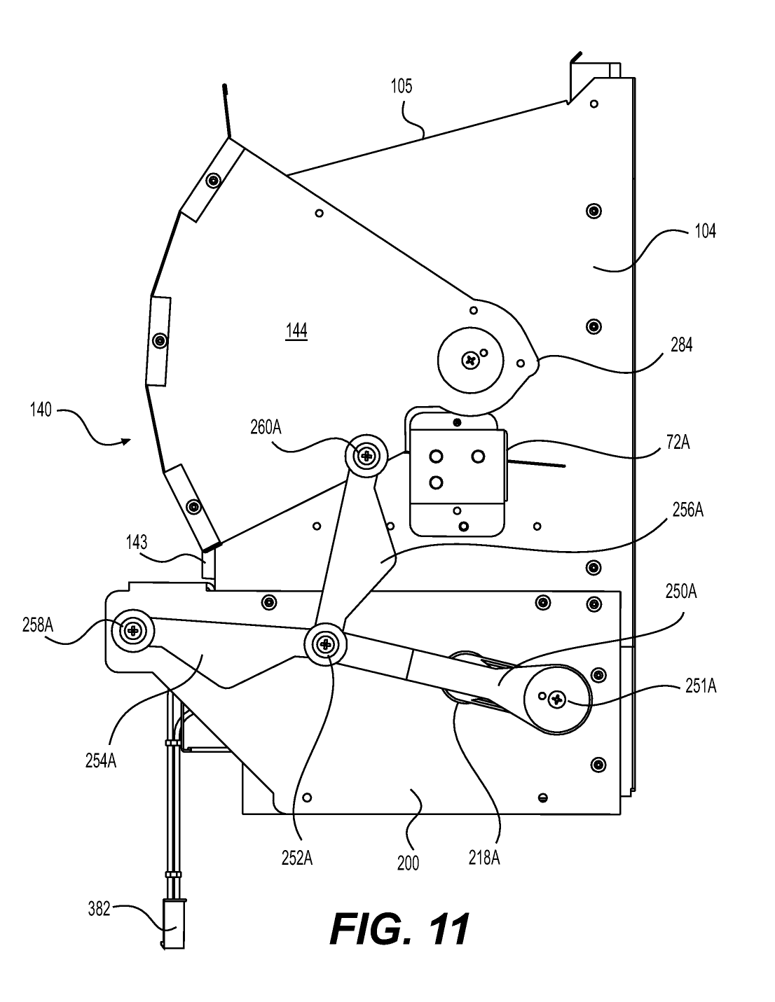

As mentioned above, the security shield 140 is pivotally mounted and is movable between open and closed positions. That movement is controlled by a series of linkages and motor 270 and drive shafts 210/216. An end 215 of the short drive shaft 216 is connected to one end of a drive link 218, as shown in FIG. 3. Link 218A on the opposite side, as in FIGS. 11-13, will be driven by drive shaft 210. The other and opposing end of drive link 218 is pivotally connected at 251 to one end of a link 250 the opposite end of link 250 being connected at a pivot point 252 to one end of a pair of links 254 and 256. The opposite end of link 254 is pivotally connected to mounting bracket 200 at a pivot connection 258 and the opposite end of link 256 is pivotally connected to an end wall 144 of the security shield 140 at a pivot connection 260. FIGS. 11-13 show the same security shield drive links, which are also connected and driven and operate as just described, but with an “A” along with the appropriate reference numeral (e.g., 250A).

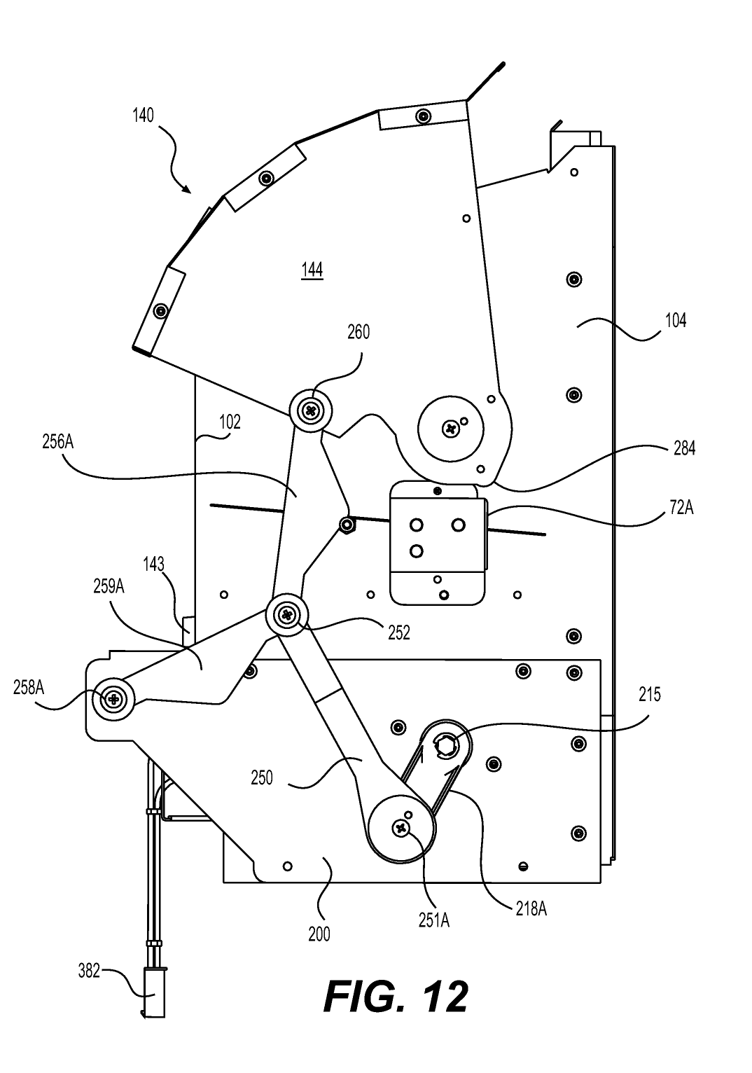

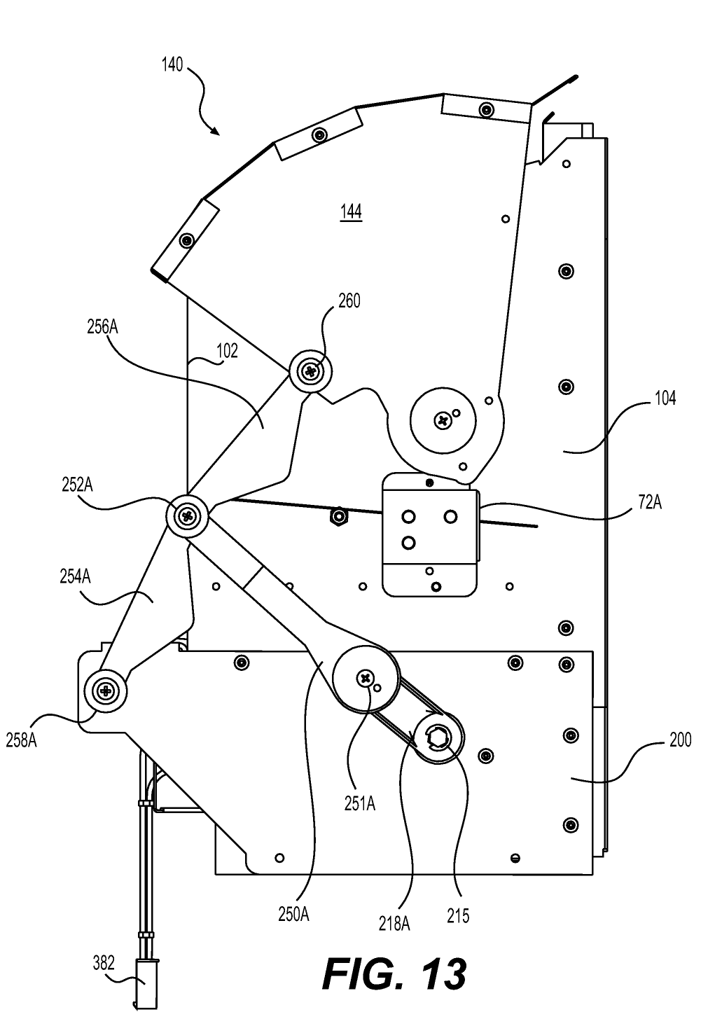

FIGS. 11-13 show the movement sequence for the rotation of the pivotally mounted security shield 140 from its open to its closed positions. As motor 270 rotates the short drive shaft 216 and the long drive shaft 210, the drive link 218 (and 218A on the opposite side) will start to rotate thereby driving links 250, 254 and 256 (and 250A, 254A and 256A) that will progressively rotate the security shield 140 from its open position (FIG. 11), where it rests on a pair of resilient stops 143 and in which dispensed product can drop or fall into the hopper assembly 100, through an intermediate position (FIG. 12) to its fully closed position (FIG. 13). When closed, security shield 140 will cover and close the top of the hopper assembly 100 thereby preventing access into vend space 62 and likewise will prevent attempts to dislodge additional products retained in the product holding section 60. FIG. 4 shows two micro switches one, switch 280, to sense the down position, and a second switch 282 to sense and then signal the fully closed position of shield 140. Switch 280 will be tripped by an extension 284 in the form of a protruding end on end wall 146, and switch 282 will be tripped or closed by an actuation plate 286 on a leading edge 288 of the end wall 146.

When the vendor begins the vend process (assuming credit, and no errors), the motor 270 will turn the drive shafts 215 and 216˜180 degrees, stopping when an actuator 284 on the security cover 140 closes a micro switch 280, signaling that the cover 140 is fully open. The half revolution also operates two cams 220 and 222 that lower the floor sections 172 and 174 and two other cams 224 and 226 that control the movement of two door locking or stop arms 134 and 136 out under the slidably mounted vend door 300 to lock it closed. If, at any time during this movement, the sliding vend door 300 opens switch 330 (indicating it is not fully up or not closed), the motor 270 will stop and activate a display stating “please close vend door” or something to that effect on the display 360 on the front of the vending machine 10. This prevents jamming the mechanisms, as well as attempts at ‘fishing’ for merchandise through the hopper assembly 100. Next, the vend motor 380 turns to dispense a selected product from the product holding section 62, relying on the Sensit® sensor system 70 to detect a successful vend and to then stop vend motor 380. If used product sensors 72A/72B can also confirm that a product is within the hopper. Then the motor 270 makes another half turn of the drive shafts 210/216, stopping when the security cover 140 is fully closed which is sensed by the activation of micro switch 282. During this half turn, the floor 170 is also raised to the minimum height required by the ADA. Also, cams 224/226 will have rotated to a position that will permit the retracting or inward movement of the locking arms 134/136 thereby unlocking door 300 to allow the vend door 300 to be lowered by the customer in order to retrieve the dispensed product from within the hopper assembly 100. When door 300 is released by the consumer it will again raise to its closed position. The vending machine will then stay at this position until another vend is requested. The hopper stays at this ‘vend’ position until another selection is made, so the door can be opened/closed as needed to access the product.

As noted previously, security shield 140 can be comprised of a one piece molded structure or preferably formed as a multi-segmented structure from, for example, 24 gauge steel. Walls 102-108 are preferably formed or stamped from 16 gauge galvanized steel, and the separate linkage members 250, 254 and 256 can also be formed or stamped from 16 gauge galvanized steel as well as the mounting brackets 200 and 202. It should be understood, however, that other gauges of sheet metal could be sued as well as other materials, informing the various parts of the hopper assembly 100.

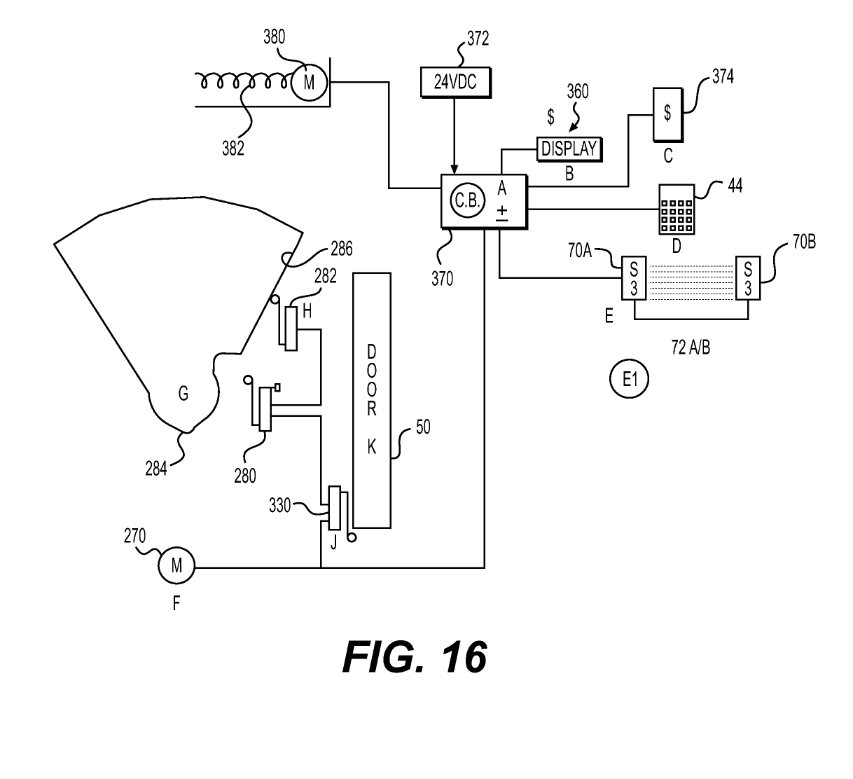

FIG. 16 shows an exemplary control circuit for this vending machine as including a control board that is powered by a 24 VDC power source 372 and is further connected to vend motors 380, a display 360, a money input device 374 that includes a suitable sensor to know the amount being paid, the keypad 44, the Sensit sensor system 70, the in-hopper sensors 72A/72B if used, the door switch 330, as well as the security shield switches 280 and 282, and hopper motor 270. Suitable wire harnesses 382 can also be provided as need to provide power or signals to the motors, sensors, and other electrical components.

### Operation

In operation, with the retrieval door 50 being in its closed condition, a consumer will insert cash or credit by inserting money into the money input device 374 and the value will be displayed on display 360. A product can then be selected via keypad 44 and the display will also show and confirm the selected item. The control board 370 will then check that vend door 300 is closed, by seeing if switch 330 is made or closed, and hopper motor 370 will then be activated for a partial rotation sufficient to fully open security shield 170 as shown in FIG. 11. If during this period door 300 is opened, with switch 330 opening, hopper motor 270 will stop and a warning will be scrolled across the display 360 that the retrieval door 300 is open. With door 300 closed, and with shield 140 fully open, as sensed by switch 280, the control board can check sensors 70, and/or 72A/72B to assure a clear vend field exists. When that condition is present, the proper vend motor will be turned on to dispense the selected product. That selected product will follow a path of travel, for example through a vend space as shown at 62, and eventually fall or drop into the interior of the hopper assembly 100 and onto the lowered floor or bottom 170. In the glass front vending machine 10 as shown herein, the dispensed product will also have fallen freely through vend space 62 and will have been detected by the Sensit® system 70 which will detect a positive vend. Once the product has been properly vended the customer's deposited money will be accepted. As the dispensed product passes through the Sensit beams the control board 370 will also stop the specific vend motor 380 and powers the hopper motor 270 to close the security shield 140, as in FIG. 13, and hopper motor 270 will stop once switch 282 is closed indicating the closed condition for shield 140. As hopper motor 270 is rotating the security shield 140 into its closed condition cams 220/222 will raise floor 170 and cams 224/226 will retract door stops 134/136 thereby unlocking door 300. The customer can then grip handle 301 to open door 300. The dispensed product, now be resting on floor 170, will have been raised to a height that is significantly higher and readily accessible permitting the consumer to remove the vended and dispensed product and then close door 300. When switch 330 is once again activated by door 300 moving to its closed or up position, the control system 370 will be reset and thereby ready for the next vend cycle.

When introducing elements of various aspects of the present invention or embodiments thereof, the articles “a,” “an,” “the” and “said” are intended to mean that there are one or more of the elements, unless stated otherwise. The terms “comprising,” “including” and “having,” and their derivatives, are intended to be open-ended terms that specify the presence of the stated features, elements, components, groups, and/or steps, but do not exclude the presence of other unstated features, elements, components, groups, and/or steps and mean that there may be additional features, elements, components, groups, and/or steps other than those listed. Moreover, the use of “top” and “bottom,” “front” and “rear,” “above,” and “below” and variations thereof and other terms of orientation are made for convenience, but does not require any particular orientation of the components. The terms of degree such as “substantially,” “about” and “approximate,” and any derivatives, as used herein mean a reasonable amount of deviation of the modified term such that the end result is not significantly changed. For example, these terms can be construed as including a deviation of at least +/−5% of the modified term if this deviation would not negate the meaning of the word it modifies.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A retrieval mechanism for a vending machine comprised of a hopper mounted therein so as to receive selected and vended product and to present the vended product at a desired height level for a consumer, the hopper comprising;
a support structure;
a security shield pivotally attached to the support structure;
a movable front retrieval door operatively secured to the support structure;
a hopper assembly having a floor comprised of first and second floor sections that are each movably connected to the support structure and to one another so as to be movable between lowered and raised positions; and
a control system for operating the movable front retrieval door, the security shield and the hopper floor in a coordinated manner.

2. The retrieval mechanism for vending machines as in claim 1 wherein the hopper has a rectangular shape, sized to maximize the product retrieval area.

3. The retrieval mechanism for vending machines as in claim 1 wherein the floor sections are pivotally connected to each other at facing inner ends.

4. The retrieval mechanism for vending machines as in claim 1 wherein the hopper assembly includes opposing side walls and the floor sections each have an outer edge that is pivotally connected to one of the opposing side walls.

5. The retrieval mechanism for vending machines as in claim 1 wherein the usable product storage space is maximized by lowering the floor sections to receive vended products and then raising the floor sections to an accepted height for retrieval of dispensed products.

6. The retrieval mechanism m for vending machines as in claim 5 wherein the vended products drop onto a tilted floor, causing them to align horizontally and therefore prevent tall items from blocking the security cover or the vend sensors.

7. The retrieval mechanism for vending machines as in claim 1 further including door stops that are mounted to the hopper to be movable between inward and outward positions to unlock and lock the retrieval door, respectively.

8. The retrieval mechanism for vending machines as in claim 7 wherein the door stops are biased in an inward and unlocked condition.

9. The retrieval mechanism for vending machines as in claim 7 further including a drive system for controlling movement of the door stops and the floor sections.

10. The retrieval mechanism for vending machines as in claim 9 wherein the drive system includes actuators for moving the floor sections between the lowered and raised positions and to move the door stops between their inward and outward positions.

11. The retrieval mechanism for vending machines as in claim 10 wherein the actuators comprise cams driven by a drive shaft that is, in turn, driven by a motor.

12. The retrieval mechanism for vending machines as in claim 9 wherein the drive system is mounted below the floor.

13. The retrieval system for vending machines as in claim 9 wherein the security shield is movable between open and closed positions by a linkage system driven and controlled by the drive system.

14. A vending machine comprising:
a housing having a top, bottom, opposing housing side walls and a rear wall, a front door operatively attached to the housing, an internal product holding assembly from which a selected product can be dispensed, a vend space having a depth defined between a front of the product holding assembly and an inside of the door and a width defined between an interior portion of the opposing side walls;
a retrieval mechanism mounted to an interior portion of the door and positioned below the product holding assembly, the retrieval mechanism including a rear wall, a pair of opposing and spaced apart hopper side walls and a floor which collectively define a hopper having an upwardly facing opening in line with the vend space so that a product dispensed from the product holding assembly will drop along a path of travel into the hopper, the floor being movably attached in the retrieval mechanism and comprising flooring sections movably attached to one another and to each of the opposing hopper side walls so as to be movable between lowered and raised positions, a front wall having a top edge that will be adjacent the level of the floor sections when raised to the raised position, a retrieval door mounted to be movable between raised and lowered positions and a retrieval door locking assembly for locking the retrieval door in a raised position, and a security shield pivotally mounted to the opposing hopper side walls so as to be movable between open and closed positions;
a drive assembly positioned beneath the floor and behind the front wall to operate the movement of the flooring sections and the retrieval door locking assembly; and
a control system for operating the vending machine, including the retrieval door locking assembly, the security shield, and the floor sections in a coordinated manner.

15. The retrieval system as in claim 14 wherein the vending machine is a glass front vending machine and the path of travel for dispensed products comprises the vend space.

16. The retrieval system as in claim 14 wherein the floor sections are pivotally connected to each other at facing inner ends, and the floor sections each have an outer edge that is pivotally connected to one of the opposing hopper side walls.

17. The retrieval mechanism for vending machines as in claim 1 wherein:
the retrieval mechanism is mounted to an interior portion of the vending machine and positioned below a product holding assembly provided therein, the support structure further including a rear wall and a pair of opposing and spaced apart hopper side walls which together with the floor collectively define a hopper having an upwardly facing opening in line with a vend space so that a product dispensed from the product holding assembly will drop along a path of travel through the vend space into the hopper, a front wall having a top edge that will be adjacent the level of the floor sections when raised to the raised position, the movable front retrieval door being mounted so as to be movable between raised and lowered positions, and a retrieval door locking assembly for locking the movable front retrieval door in a raised position, wherein the security shield movable between open and closed positions; and further includes,
a drive assembly positioned beneath the floor and behind the front wall to operate the movement of the flooring sections and the retrieval door locking assembly; and
wherein the control system further controls, in a coordinated manner, the operation of the drive assembly and the retrieval door locking assembly.

18. The retrieval system as in claim 17 wherein the floor sections are pivotally connected to each other at facing inner ends, and the floor sections each have an outer edge that is pivotally connected to one of the opposing hopper side walls.
